(19) United States
(12) Patent Application Publication
(10) Pub. No.: US 2011/0229665 A1
(43) Pub. Date: Sep. 22, 2011

(54) THERMAL SPRAY COATING FOR TRACK ROLLER FRAME

(75) Inventors: M. Brad Beardsley, Laura, IL (US); Mark D. Veliz, Metamora, IL (US); Ondrej Racek, Dunlap, IL (US)

(73) Assignee: Caterpillar Inc., Peoria, IL (US)

(21) Appl. No.: 12/827,443

(22) Filed: Jun. 30, 2010

Related U.S. Application Data
(63) Continuation-in-part of application No. 12/285,309, filed on Oct. 1, 2008.

(51) Int. Cl. B05D 3/06; B32B 1/08; B32B 7/02; B32B 9/00

(52) U.S. Cl. 428/34.1; 427/554; 428/332; 428/217; 428/457; 428/446

(57) ABSTRACT

A method for coating a component of a track roller frame track tensioning and recoil system is disclosed. The method includes irradiating a surface of the component with a continuous laser to heat the component's surface. The method also includes coating the surface of the component with a thermal spray coating after irradiating.

### CROSS-REFERENCE TO RELATED APPLICATION

This application is a continuation-in-part application based on U.S. Ser. No. 12/285,309, filed Oct. 1, 2008.

### TECHNICAL FIELD

The present disclosure is directed to a thermal spray coating and, more particularly, to surface preparation for bond enhancement of a thermal spray coating to track roller frame components.

### BACKGROUND

Several well known high temperature thermal spray methods for coating a substrate exist in the industry, such as high-velocity oxygen fuel (HVOF) spraying. HVOF is a combustion process in which oxygen is mixed with a fuel gas and ignited, forming an exhaust gas. The exhaust gas is accelerated toward a substrate via a spray torch as a metal, ceramic, or composite material is injected into the gas stream. The injected material becomes molten and is propelled at a high velocity toward the substrate to be coated. One possible shortcoming of thermal spray methods such as HVOF in some applications is that the bond strength achieved between a coating and a substrate may be limited.

U.S. Pat. No. 5,688,564 ('564), issued to Coddet et al., discloses a process for the preparation of a substrate surface to increase bond strength. The '564 patent discloses irradiating a substrate surface via a pulse laser beam immediately before applying a thermal spray coating. The pulse laser beam imparts a large amount of energy into the substrate surface in a very brief amount of time. The pulse laser may improve bond strength of the coating by creating a plasma of vaporized material that expands to cause a shockwave. The shockwave may have a cleaning and roughening effect on the substrate surface that may improve bond strength between the coating and the substrate surface.

Although the process disclosed in '564 may provide a method for affecting a shockwave effect to roughen a substrate surface, it does not allege to disclose a method for improving the coating bond for metallurgically joining the coating and the substrate. The process described in '564 does not provide a significant increase in thermal energy available at a contact surface between the substrate and the thermal spray particles.

The present disclosure is directed to overcoming one or more of the shortcomings set forth above and/or other deficiencies in the art.

### SUMMARY OF THE DISCLOSURE

In accordance with one aspect, the present disclosure is directed toward a method for coating a component of a track tensioning and recoil system of a work machine. The method comprises irradiating a surface of the component with a continuous laser to heat the component and coating the surface of the element with a thermal spray coating after irradiating. Here, coating the surface occurs between about 1 and about 20 milliseconds after irradiating the surface.

The present disclosure is also directed toward a method for coating a component of a track tensioning and recoil system of a work machine where the method comprised irradiating a surface of the component with a laser, controlling a rate of movement of the laser to produce a desired laser-affected zone of the component; and coating the surface of the component with a thermal spray coating after irradiating.

According to another aspect, the present disclosure is directed toward a component of a track tensioning and recoil system of a work machine having a coating. The component includes a substrate material, a thermal spray layer, and an interface layer bonding the substrate material to the thermal spray layer, the interface layer being about 75% or greater contaminant-free.

### BRIEF DESCRIPTION OF THE DRAWINGS

FIG. 1 is a schematic illustration of an exemplary coating system;

FIG. 2 is a detailed view of the coating system of FIG. 1;

FIG. 3 is a second detailed view of the coating system of FIG. 1; and

FIG. 4 is a flow chart of the coating system of FIG. 1

### DETAILED DESCRIPTION

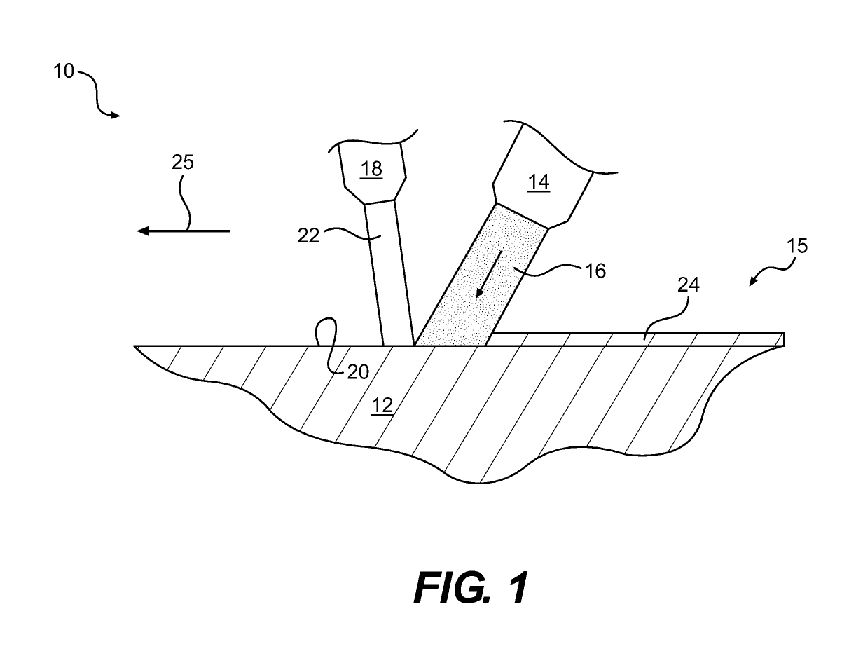

As illustrated in FIG. 1, a coating system 10 may include a depositing device 14, a laser 18, and a coating 15. Depositing device 14 may apply coating 15 to a substrate 12, and laser 18 improves a bond strength between coating 15 and substrate 12. Coating system 10 may also include an application of flux prior to the process to clean substrate 12 by thermally activating the flux via laser 18.

Depositing device 14 may be any suitable thermal spraying device for depositing a coating material 16 onto substrate 12. Coating material 16 may be deposited onto substrate 12 via any suitable method known in the art such as, for example, combustion wire spraying, combustion powder spraying, twin wire arc spraying, plasma transfer wire arc spraying, wire or powder high-velocity oxygen fuel (HVOF) spraying, or combustion flame spraying. HVOF is a combustion process where oxygen may be mixed with a fuel gas and ignited, forming an exhaust gas stream. The exhaust gas stream may be accelerated toward a substrate at high velocities such as, for example, velocities in excess of about 1000 m/s, about 1200 m/s, or even in excess of about 1400 m/s.

Coating material 16 may include powder metals or ceramic cermets that are injected generally axially or radially into the exhaust gas stream and become molten as they are propelled toward substrate 12. In some settings, high velocities of coating material 16 contribute to mechanical bond strength between coating material 16 and substrate 12. Depositing device 14 may be any suitable application device such as, for example, an HVOF spray gun, a wire arc spray gun, or a plasma arc spray gun. Coating material 16 may be in any suitable form such as, for example, powder, liquid, or wire, and may be introduced into a plasma jet produced by depositing device 14. Depositing device 14 may deposit coating material 16 via any suitable technique such as, for example, a raster motion on flat surfaces or a spiral pattern on rotating elements. Depositing device 14 forms a thermal spray layer 24 on substrate 12.

Laser 18 may be a continuous laser suitable for preparing a surface for a coating such as, for example, a neodymium-doped yttrium aluminium garnet (Nd:YAG) laser, a carbon dioxide laser, or a high power diode laser (HPDL). Further, laser 18 may be a continuous wave (CW) laser and may operate at a suitable power level for coating such as, for example, of between about 100 and about 2000 W/mm². For example, laser 18 may operate at a power level of between about 500 and about 1500 W/mm². Laser 18 may also operate at a power level of about 400 W/mm². Power level may be determined based on laser spot, which may be a surface area irradiated by laser beam 22. Laser spot may be measured based on the full width at half maximum (FWHM) of the laser power distribution across laser beam 22.

Laser 18 may be mounted on a same fixture as depositing device 14 or, alternatively, on a different fixture that precedes depositing device 14 in a direction of motion 25 to form coating 15. Laser 18 may be moved in direction of motion 25 at a suitable rate for coating such as, for example, between about 200 and about 3000 mm/s relative to substrate 12, such as between about 500 and about 1500 mm/s. Alternatively, substrate 12 may be moved at a rate of between about 200 and about 3000 mm/s relative to laser 18 and depositing device 14. For example, laser 18 may be moved at a rate of between about 500 and about 1500 mm/s. Depositing device 14 is configured to follow closely behind laser 18 in the direction of motion 25, with coating material 16 contacting a surface location at an interval such as, for example, between about 1 and about 20 milliseconds after laser 18 irradiates the surface location.

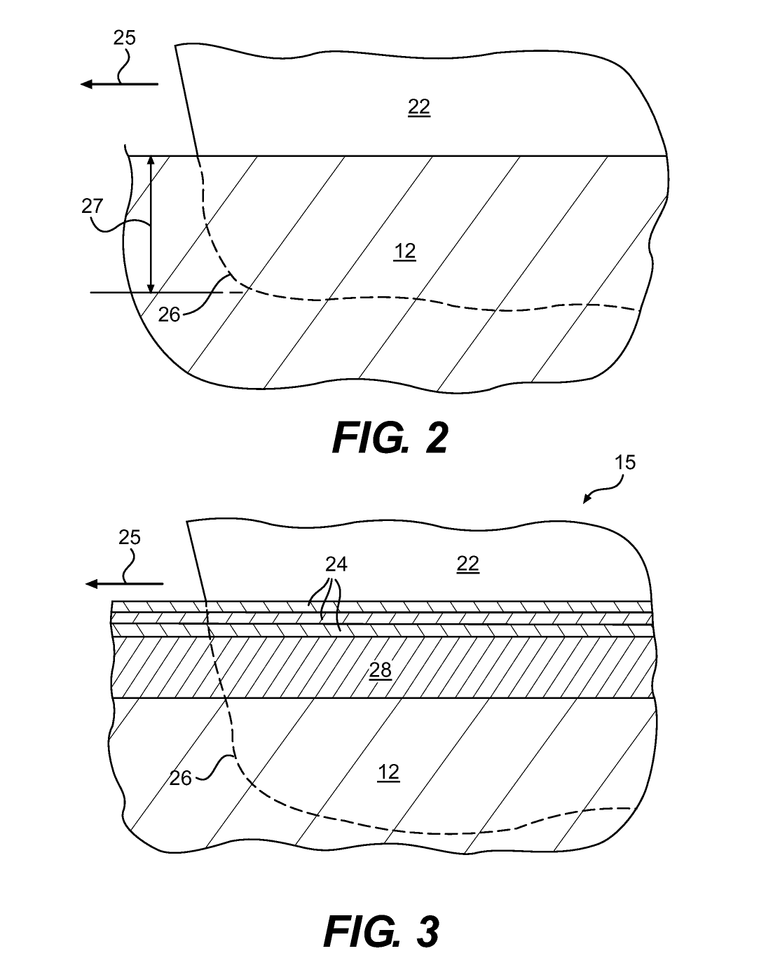

Laser 18 may emit a laser beam 22 that contacts a surface 20 of substrate 12 and/or a previously applied layer 24. As illustrated in FIG. 2, heat from laser beam 22 may produce a laser-affected zone 26 within substrate 12. Laser-affected zone 26 includes portions of substrate 12 and layers 24 having material properties that are changed by laser beam 22. For example, laser-affected zone 26 may include portions of substrate 12 and layers 24 that are heated by laser beam 22. Laser-affected zone 26 has a depth 27 that may result from a combination of parameters such as laser power, laser spot, and traverse speed. In accordance with the disclosed method, depth 27 is less than about 500 μm, such as, for example, between about 100 μm and about 200 μm. For example, depth 27 may be between about 125 and about 175 μm. The substrate properties within laser-affected zone 26, such as hardness, may vary based on rapid heating, quenching, and/or tempering. The characteristics of laser-affected zone 26 is a result of a heat gradient, in which a temperature closer to surface 20 may be higher than a temperature further away from surface 20. Laser beam 22 may heat substrate 12, within laser-affected zone 26 and near surface 20, to a maximum temperature such as, for example, of between about 0.7 and about 1.0 of the solidus temperature of substrate 12. Portions of laser-affected zone 26 near surface 20 may be any desired maximum temperature for coating such as, for example, between about 500° C. and about 1500° C. For example, laser-affected zone 26 may be between about 800° C. and about 1200° C. near surface 20.

Depth 27 and the temperature gradient of laser-affected zone 26 may affect bond strength between coating 15 and substrate 12. Although heating substrate 12 may improve bond strength, bond strength may be weakened by too much heat, i.e., by laser-affected zone 26 being too large and/or temperatures being too high. Bond strength may also be weakened by laser-affected zone 26 being too small and/or temperatures being too low. Decreasing a rate of movement of laser 18 may increase the amount of time that laser beam 22 imparts heat into a given location of substrate 12, thereby imparting more heat into substrate 12 than when laser 18 moves at a faster rate. Therefore, controlling the rate of movement of laser 18 is typically also related to the amount of heat imparted to substrate 12, and may produce a desired laser-affected zone 26 of an appropriate size and temperature for optimizing bond strength for a given coating material and substrate material. Laser-affected zone 26 may be controlled via laser 18 to avoid melting of substrate 12. Melting may be undesirable because it may significantly reduce a hardness of substrate 12.

As illustrated in FIG. 3, thermal coating 15 may include a plurality of layers 24. Each layer 24 may be applied by a pass of depositing device 14 and laser 18 across substrate 12. Coating 15 may be composed of numerous layers such as, for example, about twenty to thirty layers 24. Each layer 24 may be of any suitable dimension for coating such as, for example, between about 5 μm and about 20 μm thick, or between about 10 μm and about 15 μm thick. Further, the layer may be between about 5 mm and about 100 mm wide, such as between about 40 mm and about 60 mm wide. As laser 18 makes passes across substrate 12, an interface layer 28 may be produced within laser-affected zone 26. Interface layer 28 is a dilution zone in which substrate 12 and layers 24 are metallurgically bonded. Based on coating system 10, interface layer 28 may be substantially free of contaminants such as, for example, oxide compounds. Interface layer 28 may be at least about 75% contaminant-free. For example, based on coating system 10, interface layer 28 may be at least about 90% contaminant-free, at least about 95% contaminant-free, or at least about 99% contaminant-free.

Laser beam 22 may affect at least one previously applied layer 24 and a portion of substrate 12 to combine together to form a single interface layer 28 within laser-affected zone 26. After a suitable amount of passes of laser 18 and depositing device 14 such as, for example, between about twenty and thirty passes, interface layer 28 may have a thickness of up to about 150 μm. For example, interface layer 28 may be between about 1 μm and 100 μm thick, or between about 1 μm and 50 μm thick. Interface layer 28 may have a hardness that is greater than a hardness of substrate 12. Hardness may be measured by a suitable micro-hardness test that measures hardness of a small volume of material such as, for example, a Vickers or Knoop hardness test.

Coating system 10 may include an application of flux to clean surface 20 of substrate 12, and/or surfaces of previously applied layers 24, before irradiation by laser 18. The flux may be any suitable flux known in the art for preventing oxidation such as, for example, fluoride-containing or calcium-containing flux. Oxidation occurs when oxygen molecules interact with molecules of a surface, causing an oxide film to form that may decrease bond strength. Oxidation may occur nearly instantaneously such as, for example, when oxygen molecules contact surface 20. Any suitable method known in the art for applying a thin film of material may be used to apply the flux over an area of surface to be coated such as, for example, via a dispensing device that sprays a thin layer of flux onto a surface. The flux may be inert at relatively low temperatures such as, for example, an ambient outdoor temperature. When subjected to relatively high temperatures such as, for example, laser beam 22, the flux may react with any oxide film that has formed on surface 20 and/or surfaces of layer 24 due to oxidation, to vaporize both the flux and the oxide film. The removal of oxides prior to coating may improve a bond strength between coating 15 and substrate 12.

### INDUSTRIAL APPLICABILITY

Coating system 10 may be used in any coating application. For example, coating system 10 may be used in any manufacturing and remanufacturing applications requiring a thermal spray coating. Laser 18 may improve bond strength by producing a desired laser-affected zone 26 via laser beam 22.

Coating system 10 may be used for new manufacturing of an article, remanufacturing of an article, sealing of an article, and wear resistance applications on an article. Coating system 10 may be used on track assembly undercarriage structures, such as the track tensioning and recoil system. Such track tensioning and recoil systems are generally well known in the art, see, e.g., U.S. Pat. Nos. 4,223,878; 4,283,093; and 4,881,786, incorporated herein by reference. These track tensioning and recoil systems are the components of an undercarriage that enable appropriate constant tension to be applied to the tracks of a machine during operation, yet allow service at necessary times. The method disclosed herein may be used to apply a coating to any wear surfaces comprised therein. For example, most track tensioning and recoil systems comprise an outer member and an inner member, both of which are generally tubular, with the inner member slidably disposed within the outer member by means of bearings, such as sleeve bearings. Further, suitable seals are employed to enclose the arrangement by sealing against various features, referred to herein as seal surfaces, of the outer member, inner member, and any other moving parts that may encounter wear, such as piston surfaces. Any one of these track tensioning and recoil system components may be coated using the method disclosed herein.

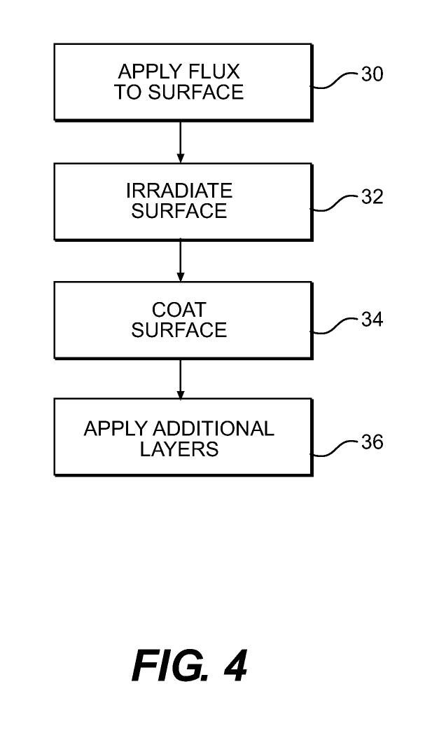

As illustrated in FIG. 4, coating 15 may be applied to substrate 12 according to method steps 30, 32, 34, and 36. In step 30, flux may be applied to surface 20. If coating 15 is being applied as part of a remanufacturing application, an appropriate amount of material may be removed from substrate 12 prior to step 30 such as, for example, about 75 μm or greater of material. In step 32, laser beam 22 may irradiate surface 20, affecting the flux to react with and vaporize any oxides that have formed on surface 20, cleaning and thereby improving characteristics of substrate 12 for bonding with coating 15. Laser beam 22 may also preheat substrate 12 within laser-affected zone 26, the preheating action improving characteristics of substrate 12 for bonding with coating 15. The rate of movement of laser 18 may be controlled to produce a desired laser-affected zone 26 that is appropriate for increasing bond strength between coating 15 and substrate 12. In step 34, depositing device 14 may apply coating material 16 to surface 20. Because depositing device 14 follows closely behind laser 18, as described above, there may not be enough time for an oxide film to be produced on surface 20. In step 36, additional layers 24 may be applied to substrate 12 in a manner similar to steps 30, 32, and 34, in which flux may be applied to a surface of each applied layer 24 to improve bonding of each subsequent layer 24. Iterative passes of laser 18 and depositing device 14 may produce a coating 15 having an interface layer 28 that is substantially oxide-free. Coating 15 may be machined, if required.

Coating system 10 may improve the bond strength between coating 15 and substrate 12. Controlling a rate of movement of laser 18 may produce a desired laser-affected zone 26 of substrate 12, which may improve bond strength. A desired laser-affected zone 26 may be selected, based on material properties of substrate 12 and coating 15, to achieve a desired bond strength. Controlling laser-affected zone 26 may thereby achieve a desired, uniform bond strength. Coating system 10 may also provide a relatively small interface layer 28 having metallurgical properties that may improve bonding between coating 15 and substrate 12. Metallurgical properties of interface layer 28 may also reduce the probability of feathering (i.e., removing coating and exposing uncoated substrate material) during machining after applying coating 15. Laser 18 may also clean a surface to be coated, which may improve bond strength of coating 15 and may eliminate the need for grit-blasting the surface.

It will be apparent to those skilled in the art that various modifications and variations can be made to the disclosed coating system. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for coating a component of a track tensioning and recoil system of a work machine, the method comprising:
irradiating a surface of the component with a continuous laser to heat the component; and
coating the surface of the element with a thermal spray coating after irradiating, wherein coating the surface occurs between about 1 and about 20 milliseconds after irradiating the surface

2. The method of claim 1, wherein a rate of movement between the continuous laser and the surface of the component is between about 200 and about 3000 mm/s relative to a substrate.

3. The method of claim 1, wherein the continuous laser operates at a power level of between about 100 and about 2000 W/mm².

4. The method of claim 3, wherein the continuous laser operates at a power level of about 400 W/mm².

5. A method for coating a component of a track tensioning and recoil system of a work machine, the method comprising:
irradiating a surface of the component with a laser;
controlling a rate of movement of the laser to produce a desired laser-affected zone of the component; and
coating the surface of the component with a thermal spray coating after irradiating.

6. The method of claim 5, wherein a depth of the laser-affected zone is not more than about 500 μm.

7. The method of claim 5, wherein a depth of the laser-affected zone is between about 100 μm and about 200 μm.

8. The method of claim 5, wherein a maximum temperature of the laser-affected zone is between about 0.7 and about 1.0 of the solidus temperature of the element.

9. The method of claim 5, wherein a maximum temperature of the laser-affected zone is between about 500° C. and about 1500° C.

10. A component of a track tensioning and recoil system of a work machine, comprising:
a substrate material;
a thermal spray layer; and
an interface layer bonding the substrate material to the thermal spray layer, the interface layer being about 75% or greater contaminant-free.

11. The component of claim 10, wherein the interface layer is about 90% or greater contaminant-free.

12. The component of claim 10, wherein the interface layer is about 95% or greater contaminant-free.

13. The component of claim 10, wherein the interface layer has a hardness that is greater than a substrate material hardness.

14. The component of claim 10, wherein the interface layer is between about 1 μm and about 150 μm thick.

15. The component of claim 10, wherein the component is a seal surface.

16. The component of claim 10, wherein the component is a piston surface.

17. The component of claim 10, wherein the component is a sleeve bearing.

18. The component of claim 10, wherein the component is a first tubular member.
